(19) United States
(12) Patent Application Publication
(10) Pub. No.: US 2025/0215224 A1
(43) Pub. Date: Jul. 3, 2025

(54) VISCOELASTIC RESIN COMPOSITION AND MOLDED ARTICLE THEREOF

(71) Applicants: Hyundai Motor Company, Seoul (KR); Kia Corporation, Seoul (KR)

(72) Inventor: Hyun Jun Kim, Hwaseong (KR)

(21) Appl. No.: 18/946,022

(22) Filed: Nov. 13, 2024

(30) Foreign Application Priority Data
Jan. 3, 2024 (KR) 10-2024-0001032

(51) Int. Cl. C08L 77/10; C08K 7/14

(52) U.S. Cl. CPC C08L 77/10; C08K 7/14; C08L 2203/20; C08L 2205/025

(57) ABSTRACT

Disclosed is a viscoelastic resin composition including: an aliphatic polyamide-based resin including a repeating unit represented by a following Chemical Formula 1; and an aromatic polyamide-based resin, wherein a weight ratio of the aliphatic polyamide-based resin and the aromatic polyamide-based resin is in a range of 1:4 to 1:0.25:

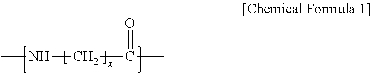

where in the Chemical Formula 1, X is a natural number from 4 to 8.

### CROSS-REFERENCE TO RELATED APPLICATION

This application claims under 35 U.S.C. § 119 (α) the benefit of Korean Patent Application No. 10-2024-0001032, filed in the Korean Intellectual Property Office on Jan. 3, 2024, the entire contents of which are incorporated herein by reference.

### TECHNICAL FIELD

The present disclosure relates to a viscoelastic resin composition and a molded article formed using the same.

### BACKGROUND

Power generation devices (e.g. engines, turbines, motors, etc.) that receive various types of energy from raw materials and convert them into mechanical movement have been widely used in transportation, means of movement, home appliances, and electronic products. For example, internal combustion engine vehicles that use a combustion engine as a power generation device and electric mobility such as electric vehicles that use a motor as a power generation device are widely used in real life.

When operating the above-described power generation device, unintended vibration may occur, leading to noise issues. In particular, in recent years, consumers' awareness of high-frequency indoor noise generated by driving the motor of the electric vehicle has been increasing. Such high-frequency noise has not been a major problem in existing means of transportation/mobility, such as internal combustion engines cars, but it is a new issue emerging in electric mobility, such as electric vehicles, whose distribution has recently accelerated significantly.

The above-described high-frequency indoor noise problem may occur because the vibration and noise generation mechanism caused by driving the motor is different from the vibration and noise generation mechanism caused by operating a conventional combustion engine. More specifically, the motor of the electric mobility converts electrical energy into rotational energy, which differs from the driving scheme of the conventional combustion engine. Therefore, the noise generated in the electric mobility, such as the electric vehicles, may be different in a frequency level from low-frequency noise that is mainly a problem in the existing internal combustion engine vehicles.

The amount of the above-mentioned noise may vary depending on a type of a material used for a housing or a cover of the various parts that constitute the motor. For example, aluminum or plastic (e.g., polyamide 6, which is widely used commercially) are materials commonly used in the conventional combustion engines. While these materials have excellent mechanical properties and heat resistance, they have relatively poor ability to absorb and suppress vibrations that cause the high-frequency noise. Therefore, when materials such as the aluminum or plastic are used in electric mobility motors, there is a problem with vibrations causing high-frequency noise due to the rotation of the motor.

### SUMMARY

The present disclosure has been made to solve the above-mentioned problems occurring in the prior art while advantages achieved by the prior art are maintained intact. Thus, a purpose of the present disclosure is to provide a viscoelastic resin composition with improved damping performance against vibrations that cause high-frequency noise, and a molded article formed using the same.

According to an aspect of the present disclosure, provided is a viscoelastic resin composition comprising: an aliphatic polyamide-based resin; and an aromatic polyamide-based resin, wherein a weight ratio of the aliphatic polyamide-based resin and the aromatic polyamide-based resin is in a range of about 1:4 to about 1:0.25:

The aliphatic polyamide-based resin may include a repeating unit represented by a following

### Chemical Formula

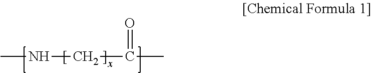

where in the Chemical Formula 1, X is a natural number from 4 to 8.

The aliphatic polyamide-based resin may be PA5 (nylon 5), PA6 (nylon 6), PA7 (nylon 7), a copolymer thereof, or a blend thereof wherein a weight-average molecular weight of the aliphatic polyamide-based resin is in a range of 1000 to 80000 g/mol.

The aromatic polyamide-based resin may be a polyphthalamide resin, a copolymer thereof, or a blend thereof.

The polyphthalamide resin may include at least one repeating unit selected from a group consisting of a repeating unit represented by a following Chemical Formula 2 and a repeating unit represented by a following Chemical Formula 3:

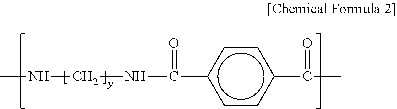

where in the Chemical Formula 2, Y is a natural number from 5 to 12,

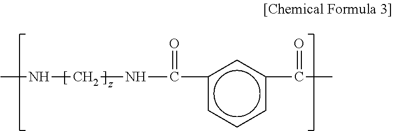

where in the Chemical Formula 3, Z is a natural number from 5 to 12.

The polyphthalamide resin is a copolymer that may include the repeating unit represented by the Chemical Formula 2 and the repeating unit represented by the Chemical Formula 3, and each of Y in the Chemical Formula 2 and Z in the Chemical Formula 3 may be independently a natural number from 4 to 8.

A weight-average molecular weight of the aliphatic polyamide-based resin may be in a range of about 1000 to about 80000 g/mol, and a weight-average molecular weight of the aromatic polyamide-based resin may be in a range of about 2000 to about 150000 g/mol.

The weight ratio of the aliphatic polyamide-based resin and the aromatic polyamide-based resin is in a range of about 1:4 to about 1:1.

The viscoelastic resin composition may further include a filler. The filler may be a fibrous reinforcing material.

The fibrous reinforcing material may include at least one selected from a group consisting of glass fiber, carbon fiber, graphite fiber, metal fiber, basalt fiber, cotton fiber, wool fiber, silk fiber, aramid fiber, polyacrylonitrile fiber, arylate fiber, polyether ketone fiber, nylon fiber, and polyarylene terephthalate fiber, and a combination thereof.

When a total weight of the aliphatic polyamide-based resin, the aromatic polyamide-based resin, and the filler is 100 parts by weight, a content of the filler may be in a range of about 30 to about 40 parts by weight.

The viscoelastic resin composition may further include at least one selected from a group consisting of a heat resistant agent and, a lubricant, and a combination thereof.

The heat resistant agent may be at least one selected from a group consisting of a phenol-based compound; an amine-based compound; an oxide or hydroxide of Mg, Al, Sb, Zn or Mo; and an iodinated inorganic compound, and a combination thereof.

The lubricant may be at least one selected from a group consisting of a polyolefin-based compound, N,N′-bis(2,2,6,6-tetramethyl-4-piperidinyl), 1,3-benzenedicarboxamide, and HALS, and a combination thereof.

Also provided is a molded article of the viscoelastic resin composition.

A loss tangent (tan δ) of the molded article at 80° C. in a temperature-dependent graph of a loss tangent (tan δ) is in a range of 0.068 inclusive to 0.090 inclusive may be in a range of 0.068 inclusive to 0.090 inclusive when obtained by measuring the molded article under a following measurement condition: a dynamic viscoelastic behavior of a rectangular molded article having a length of 60 mm, a width of 13 mm, and a height of 3 mm manufactured using the viscoelastic resin composition is analyzed in a single cantilever bending mode (a measurement temperature range: 0 to 200° C., a temperature increase rate: 3° C./min, a measurement frequency: 3.2 Hz, a strain amplitude: 10 μm), and the temperature-dependent graph of the loss tangent (tan δ) is obtained based on the analyzed dynamic viscoelastic behavior.

An integral value of the loss tangent (tan δ) in a temperature range of 60° C. to 120° C. in the temperature-dependent graph of the loss tangent (tan δ) may be in a range of 3.1 inclusive to 4.2 inclusive.

The temperature-dependent graph of the loss tangent (tan δ) may have a maximum value in a temperature range from 60° C. to 120° C.

As discussed, the method and system suitably include use of a controller or processer.

In another embodiment, vehicles are provided that comprise an apparatus as disclosed herein.

### BRIEF DESCRIPTION OF THE DRAWINGS

The above and other objects, features and advantages of the present disclosure will be more apparent from the following detailed description taken in conjunction with the accompanying drawings:

FIG. 1A is a temperature-dependent graph of a loss tangent (tan δ) obtained by measuring dynamic viscoelasticity of a specimen of Present Example 1 of the present disclosure;

FIG. 1B is a temperature-dependent graph of a loss tangent (tan δ) obtained by measuring dynamic viscoelasticity of a specimen of Present Example 2 of the present disclosure;

FIG. 1C is a temperature-dependent graph of a loss tangent (tan δ) obtained by measuring dynamic viscoelasticity of a specimen of Present Example 3 of the present disclosure;

FIG. 2A is a temperature-dependent graph of a loss tangent (tan δ) obtained by measuring dynamic viscoelasticity of a specimen of Comparative Example 1 of the present disclosure;

FIG. 2B is a temperature-dependent graph of a loss tangent (tan δ) obtained by measuring dynamic viscoelasticity of a specimen of Comparative Example 2 of the present disclosure;

FIG. 2C is a temperature-dependent graph of a loss tangent (tan δ) obtained by measuring dynamic viscoelasticity of a specimen of Comparative Example 3 of the present disclosure;

FIG. 2D is a temperature-dependent graph of a loss tangent (tan δ) obtained by measuring dynamic viscoelasticity of a specimen of Comparative Example 4 of the present disclosure;

FIG. 2E is a temperature-dependent graph of a loss tangent (tan δ) obtained by measuring dynamic viscoelasticity of a specimen of Comparative Example 5 of the present disclosure;

FIG. 2F is a temperature-dependent graph of a loss tangent (tan δ) obtained by measuring dynamic viscoelasticity of a specimen of Comparative Example 6 of the present disclosure;

FIG. 2G is a temperature-dependent graph of a loss tangent (tan δ) obtained by measuring dynamic viscoelasticity of a specimen of Comparative Example 7 of the present disclosure;

FIG. 2H is a temperature-dependent graph of a loss tangent (tan δ) obtained by measuring dynamic viscoelasticity of a specimen of Comparative Example 8 of the present disclosure; and

FIG. 3 is a frequency-dependent graph of an amplitude measured on the specimen of each of Present Example 2, Comparative Example 2, and Comparative Example 8 of the present disclosure using a complex environmental vibration tester.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, the viscoelastic resin composition and the molded article formed using the same will be described in detail so that those skilled in the art may easily practice the same.

### Viscoelastic Resin Composition

The viscoelastic resin composition of the present disclosure includes an aliphatic polyamide-based resin and an aromatic polyamide-based resin. In this case, a weight ratio of the aliphatic polyamide-based resin and the aromatic polyamide-based resin may be in the range of 1:4 to 1:0.25, 1:3.8 to 1:0.3, 1:3.5 to 1:0.35, 1:3 to 1:0.35, or 1:2.6 to 1:0.39. When the viscoelastic resin composition includes the aliphatic polyamide-based resin and the aromatic polyamide-based resin in the above-described weight ratio range, a molded article formed using the viscoelastic resin composition may have excellent mechanical properties, heat resistance, and damping performance against vibrations that cause high-frequency noise.

The aliphatic polyamide-based resin may include a repeating unit represented by a following Chemical Formula 1. The aliphatic polyamide-based resin may serve to improve the mechanical properties and heat resistance of the molded article formed using the viscoelastic resin composition.

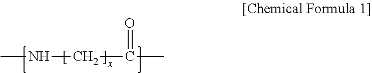

In the Chemical Formula 1, X is a natural number from 4 to 8.

Preferably, the aliphatic polyamide-based resin may be a homopolymer, an alternating copolymer, a block copolymer, or a random copolymer including the repeating unit represented by the Chemical Formula 1 as a main constituent unit, or a blend as a mixture thereof. In this regard, including as the repeating unit represented by the Chemical Formula 1 as the main constituent unit means that the polymer contains 80 mol %, 85 mol %, or 90 mol % or greater of the repeating units represented by the following Chemical Formula 1, preferably, 95 mol % or greater, and most preferably 99.99 mol % or greater, based on 100% of the total of repeating units of the polymer.

In one embodiment, preferably, the aliphatic polyamide-based resin may be PA5 (nylon 5), PA6 (nylon 6), PA7 (nylon 7), copolymers thereof, or blends thereof. More preferably, the aliphatic polyamide-based resin may be PA6, which is easily commercially available and suitable for mass production.

In one embodiment, the weight-average molecular weight of the aliphatic polyamide-based resin may be in the range of 1000 to 80000 g/mol; 1500 to 70000 g/mol; 5000 to 65000 g/mol; 10000 to 57000 g/mol; or 15000 to 50000 g/mol.

The aromatic polyamide-based resin may serve to reduce moisture absorption and improve the mechanical properties and damping performance of the molded article formed using the viscoelastic resin composition.

In one embodiment, the aromatic polyamide-based resin may be a polyphthalamide resin, a copolymer thereof, or a blend thereof. In this regard, the polyphthalamide resin may include at least one repeating unit selected from a group consisting of a repeating unit represented by a following Chemical Formula 2 and a repeating unit represented by a following Chemical Formula 3.

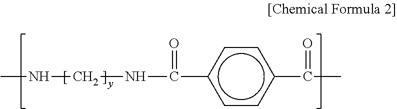

where in the Chemical Formula 2, Y is a natural number from 5 to 12,

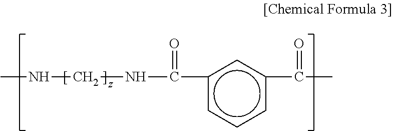

where in the Chemical Formula 3, Z is a natural number from 5 to 12.

In one embodiment, preferably, the polyphthalamide resin may be a copolymer including both the repeating unit represented by the Chemical Formula 2 and the repeating unit represented by the Chemical Formula 3. In this regard, each of Y in the Chemical Formula 2 and Z in the Chemical Formula 3 may independently be 4 to 8, 5 to 8, 4 to 7, 5 to 7, 6 to 7, or 6. In this case, the damping performance of the molded article formed using the viscoelastic resin composition may be further improved.

In one embodiment, the weight-average molecular weight of the aromatic polyamide-based resin may be in the range of 2000 to 150000 g/mol; 3000 to 1450000 g/mol; 7000 to 120000 g/mol; 15000 to 100000 g/mol; or 20000 to 85000 g/mol.

In one embodiment, preferably, a content of the aromatic polyamide-based resin contained in the viscoelastic resin composition may be greater than or equal to a content of the aliphatic polyamide-based resin contained therein. More preferably, the content of the aromatic polyamide-based resin may be greater than the content of the aliphatic polyamide-based resin. For example, preferably, the weight ratio of the aliphatic polyamide-based resin and the aromatic polyamide-based resin contained in the viscoelastic resin composition may be in the range of 1:4 to 1:1, 1:3.8 to 1:1, 1:3.5 to 1:1, 1:3 to 1:1, or 1:2.6 to 1:1. More preferably, the weight ratio thereof may be in the range of 1:4 to 1:1.05, 1:3.8 to 1:1.05, 1:3.5 to 1:1.05, 1:3 to 1:1.05, or 1:2.6 to 1:1.05. In this regard, when the weight ratio satisfies the above-mentioned range, each of the damping performance in a temperature range of 60 to 120° C. and the damping performance at 80° C. of the molded article formed using the viscoelastic resin composition may be further improved.

In one embodiment, the viscoelastic resin composition may further include a filler. The filler is intended to improve heat-and-moisture resistance, acid resistance, alkali resistance, mechanical strength, elastic modulus, elongation, and dimensional stability. Preferably, the filler may be a fibrous reinforcing material.

In one embodiment, the fibrous reinforcing material may include at least one selected from a group consisting of glass fiber, carbon fiber, graphite fiber, metal fiber, basalt fiber, cotton fiber, wool fiber, silk fiber, aramid fiber, polyacrylonitrile fiber, arylate fiber, polyether ketone fiber, nylon fiber, and polyarylene terephthalate fiber. Preferably, the fibrous reinforcing material may include glass fiber.

In one embodiment, the fibrous reinforcing material may have a chopped strand form having a diameter of 5 to 30 μm, 7 to 23 μm, or 9 to 14 μm and a length of 2 to 12 mm, 3 to 10 mm, or 4 to 8 mm.

In one embodiment, when a total weight of the aliphatic polyamide-based resin, the aromatic polyamide-based resin, and the filler is 100 parts by weight, a content of the filler in the viscoelastic resin composition may be in the range of 30 to 40 parts by weight, 31 to 39 parts by weight, or 32 to 38 parts by weight. In this regard, when the content of the filler satisfies the above-mentioned range, heat-and-moisture resistance, acid resistance, alkali resistance, mechanical strength, elastic modulus, elongation, and dimensional stability of the molded article formed using the viscoelastic resin composition may be further improved.

In one embodiment, the viscoelastic resin composition may further include at least one selected from a group consisting of a heat resistant agent and a lubricant.

The heat resistant agent may be at least one selected from a group consisting of a phenol-based compound; an amine-based compound; an oxide or hydroxide of Mg, Al, Sb, Zn or Mo; and an iodinated inorganic compound. The iodinated inorganic compound may be, for example, Cul, KI, or a combination thereof.

In one embodiment, the viscoelastic resin composition may contain 0.2 to 0.6, 0.3 to 0.5, or 0.25 to 0.45 parts by weight of the heat resistant agent based on 100 parts by weight being a total weight of the aromatic polyamide-based resin and the aliphatic polyamide-based resin. In this regard, when the viscoelastic resin composition contains the heat resistant agent in the above-mentioned range, the economic feasibility of the viscoelastic resin composition may be secured, while sufficient heat resistance characteristics of the molded article formed using the viscoelastic resin composition may be secured.

In one embodiment, the lubricant may be at least one selected from a group consisting of a polyolefin compound, N,N′-bis(2,2,6,6-tetramethyl-4-piperidinyl), 1,3-benzenedicarboxamide, and HALS. The polyolefin-based compound may be, for example, polyethylene wax.

In one embodiment, the viscoelastic resin composition may contain 0.25 to 0.55, 0.3 to 0.5, or 0.35 to 0.45 parts by weight of the lubricant based on 100 parts by weight being the total weight of the aromatic polyamide-based resin and the aliphatic polyamide-based resin. In this regard, when the viscoelastic resin composition contains the lubricant within the above-mentioned range, shear stress may be reduced, decomposition of the aromatic polyamide-based resin and the aliphatic polyamide-based resin may be minimized, and process stability may be improved during the molding process of forming the molded article using the viscoelastic resin composition.

### Molded Article

The molded article in accordance with the present disclosure is formed by molding the viscoelastic resin composition as described above. In this regard, a method of molding the viscoelastic resin composition is not particularly limited, and various known molding methods may be applied. For example, the ingredients as described above contained in the viscoelastic resin composition may be pre-mixed with each other using various mixers such as a tumbler or Hanssell mixer, and the mixture may be then melted and kneaded using a mixer, roll, bender, single-screw extruder, multi-screw extruder, kneader, etc. to form the molded article. Moreover, the ingredients described above contained in the viscoelastic resin composition may be supplied to an extruder, etc. in a non-pre-mixed state. Alternatively, only some of the ingredients may be pre-mixed with each other and the mixture may be supplied to an extruder, etc., with the remaining ingredients then being supplied to the extruder, etc. using a feeder, etc.

The molded article may have excellent mechanical properties and excellent heat resistance derived from the aliphatic polyamide-based resin contained in the viscoelastic resin composition, and may have excellent damping performance derived from aromatic polyamide-based resin. In this regard, as a mass ratio of the aliphatic polyamide-based resin and the aromatic polyamide-based resin contained in the viscoelastic resin composition satisfies the above-mentioned optimal mass ratio, the molded article may have excellent damping performance against the vibration causing the high-frequency noise.

In this regard, one measure of the damping performance of the molded article may be a loss tangent (tan δ). The loss tangent (tan δ) is expressed as a ratio of a loss modulus (G) and a storage modulus (G′), as shown in a following Equation 1. In this regard, the storage modulus (G) is a measure of the energy stored in a given deformation, and the loss modulus (G) is a measure of a ratio at which energy is lost due to a phase difference due to the viscous behavior of a sample.

$$tan δ = {G}^{‶} χ {G}^{‵} \qquad [ Equation 1 ]$$

When, in the Equation 1, the loss tangent (tan δ) is greater than 1, the viscous properties may be greater than the elastic properties. Conversely, when the loss tangent (tan δ) is smaller than 1, the elastic properties may be greater than the viscous properties. In other words, the loss tangent (tan δ) may be a measure of the viscoelasticity of the sample.

In one example, in one embodiment, the molded article may be used to form various types of power generation devices known in the art. For example, the molded article may be used to form a housing (e.g., a case, a cover, a frame, etc.) of an electric motor (or parts thereof) for electric mobility such as an electric vehicle. In this regard, the temperature at which the power generation device operates may be generally in the range of 60 to 120° C., in particular, around 80° C.

In one embodiment, in a temperature-dependent graph of the loss tangent (tan δ) of the molded article obtained by measuring under a following measurement condition, the loss tangent (tan δ) thereof at 80° C. may be in the range of 0.068 inclusive to 0.090 inclusive. Accordingly, in particular, vibrations derived from the electric mobility that causes noise with a frequency of a 6.0 to 7.0 kHz band, among vibrations that may occur when driving the power generation device manufactured with the molded article at 80° C. may be effectively attenuated, while sufficient mechanical strength and heat resistance at 80° C. may be secured.

### [Measurement Condition]

A dynamic viscoelastic behavior of a rectangular molded article having a length of 60 mm, a width of 13 mm, and a height of 3 mm manufactured using the viscoelastic resin composition is analyzed in a single cantilever bending mode (a measurement temperature range: 0 to 200° C., a temperature increase rate: 3° C./min, a measurement frequency: 3.2 Hz, a strain amplitude: 10 μm), and the temperature-dependent graph of the loss tangent (tan δ) is obtained based on the analyzed dynamic viscoelastic behavior.

In one embodiment, an integral value of the loss tangent (tan δ) in a temperature range of 60° C. to 120° C. in the temperature-dependent graph of the loss tangent (tan δ) may be in the range of 3.1 inclusive to 4.2 inclusive. In this case, preferably, the temperature-dependent graph of the loss tangent (tan δ) may have a maximum value in a temperature range from 60° C. to 120° C. In this regard, when the temperature-dependent graph of the loss tangent (tan δ) satisfies the above-mentioned condition, in particular, vibrations derived from the electric mobility that causes noise with a frequency of a 6.0 to 7.0 kHz band, among vibrations that may occur when driving the power generation device manufactured with the molded article at 80° C. may be effectively attenuated, while sufficient mechanical strength and heat resistance may be secured in a temperature range from 60° C. to 120° C.

Hereinafter, the present disclosure is described in more detail through examples. However, these examples are only intended to help understand the present disclosure, and the scope of the present disclosure is not limited to these examples in any way.

### Present Example 1: Specimen of Molded Article Formed Using Viscoelastic Resin Composition

PA6 (nylon 6, Ultramid 1031CH prepared by BASF), PA6T/6I (polyphthalamide 6T/6I, A-8000 prepared by Solvay) and glass fiber (1111 prepared by Owens Corning) were mixed with each other at a weight ratio of 20:45:3 to prepare a mixture. 0.4 phr of a heat resistant agent (VALERAS, prepared by BASF) and 0.4 phr of a lubricant (Plastomoll, prepared by BASF) were added to the mixture to prepare a composition. Then, pellets were prepared by extruding and cooling the composition. The obtained pellets were put into an injection molding machine to manufacture a rectangular parallelepiped specimen which was 60 mm long, 13 mm wide, and 3 mm high.

### Present Examples 2 to 12: Specimens of Molded Articles Formed Using Viscoelastic Resin Composition

The same procedure as in Present Example 1, except that types and/or contents of the ingredients contained in the composition were changed as shown in Table 1 below, was performed to manufacture a rectangular parallelepiped specimen with a length of 60 mm, a width of 13 mm, and a height of 3 mm.

### Comparative Examples 1 to 8: Specimens of Molded Articles Formed Using Resin Composition

The same procedure as in Present Example 1 except that types and/or contents of the ingredients contained in the composition were changed as shown in Table 1 below was performed to manufacture a rectangular parallelepiped specimen with a length of 60 mm, a width of 13 mm, and a height of 3 mm.

In Table 1 below, PA66 (nylon 66) was A218 prepared by BASF, PA6T/66 (polyphthalamide 6T/66) was A-4000 prepared by Solvay, and PA9T (polyphthalamide 9T) was Genestar prepared by Kuraray, and PA10T (polyphthalamide 10T) was Amodel bios prepared by Solvay.

TABLE 1

| | Aliphatic polyamide- | | | | | | Glass | Additives [phr] | |
|---|---|---|---|---|---|---|---|---|---|
| | based resin | | Aromatic polyamide-based resin | | | | fiber | Heat | |
| | [Part by weight] | | [Part by weight] | | | | [Part by | Resistant | |
| | PA6 | PA66 | PA6T/6I | PA6T/66 | PA9T | PA10T | weight] | agent | Lubricant |
| Present | 20.0 | 0 | 45.0 | 0 | 0 | 0 | 35.0 | 0.4 | 0.4 |
| Example 1 | | | | | | | | | |
| Present | 32.5 | 0 | 32.5 | 0 | 0 | 0 | 35.0 | 0.4 | 0.4 |
| Example 2 | | | | | | | | | |
| Present | 45.0 | 0 | 20.0 | 0 | 0 | 0 | 35.0 | 0.4 | 0.4 |
| Example 3 | | | | | | | | | |
| Present | 20.0 | 0 | 0 | 45.0 | 0 | 0 | 35.0 | 0.4 | 0.4 |
| Example 4 | | | | | | | | | |
| Present | 32.5 | 0 | 0 | 32.5 | 0 | 0 | 35.0 | 0.4 | 0.4 |
| Example 5 | | | | | | | | | |
| Present | 45.0 | 0 | 0 | 20.0 | 0 | 0 | 35.0 | 0.4 | 0.4 |
| Example 6 | | | | | | | | | |
| Present | 20.0 | 0 | 0 | 0 | 45.0 | 0 | 35.0 | 0.4 | 0.4 |
| Example 7 | | | | | | | | | |
| Present | 32.5 | 0 | 0 | 0 | 32.5 | 0 | 35.0 | 0.4 | 0.4 |
| Example 8 | | | | | | | | | |
| Present | 45.0 | 0 | 0 | 0 | 20.0 | 0 | 35.0 | 0.4 | 0.4 |
| Example 9 | | | | | | | | | |
| Present | 20.0 | 0 | 0 | 0 | 0 | 45.0 | 35.0 | 0.4 | 0.4 |
| Example 10 | | | | | | | | | |
| Present | 32.5 | 0 | 0 | 0 | 0 | 32.5 | 35.0 | 0.4 | 0.4 |
| Example 11 | | | | | | | | | |
| Present | 45.0 | 0 | 0 | 0 | 0 | 20.0 | 35.0 | 0.4 | 0.4 |
| Example 12 | | | | | | | | | |
| Comparative | 65.0 | 0 | 0 | 0 | 0 | 0 | 35.0 | 0.4 | 0.4 |
| Example 1 | | | | | | | | | |
| Comparative | 0 | 65.0 | 0 | 0 | 0 | 0 | 35.0 | 0.4 | 0.4 |
| Example 2 | | | | | | | | | |
| Comparative | 20.0 | 45.0 | 0 | 0 | 0 | 0 | 35.0 | 0.4 | 0.4 |
| Example 3 | | | | | | | | | |
| Comparative | 32.5 | 32.5 | 0 | 0 | 0 | 0 | 35.0 | 0.4 | 0.4 |
| Example 4 | | | | | | | | | |
| Comparative | 45.0 | 20.0 | 0 | 0 | 0 | 0 | 35.0 | 0.4 | 0.4 |
| Example 5 | | | | | | | | | |
| Comparative | 0 | 20.0 | 45.0 | 0 | 0 | 0 | 35.0 | 0.4 | 0.4 |
| Example 6 | | | | | | | | | |
| Comparative | 0 | 32.5 | 32.5 | 0 | 0 | 0 | 35.0 | 0.4 | 0.4 |
| Example 7 | | | | | | | | | |
| Comparative | 0 | 45.0 | 20.0 | 0 | 0 | 0 | 35.0 | 0.4 | 0.4 |
| Example 8 | | | | | | | | | |

### Experimental Example 1: Measuring of Dynamic Viscoelasticity of Each of Specimens of Present

### Examples 1 to 12 and Comparative Examples 1 to 8

The dynamic viscoelastic behavior of each of the specimens from Present Examples 1 to 12 and Comparative Examples 1 to 8 was analyzed in the single cantilever bending mode (measurement temperature range: 0 to 200° C., temperature increase rate: 3° C./min, measurement frequency: 3.2 Hz, strain amplitude: 10 μm). Based on the analysis result, a temperature-dependent graph of a loss tangent (tan δ) was obtained.

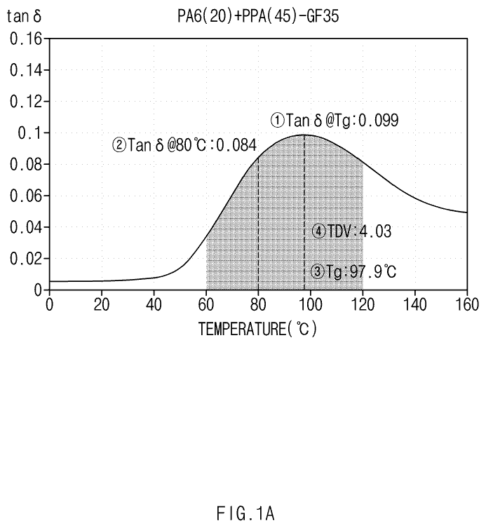

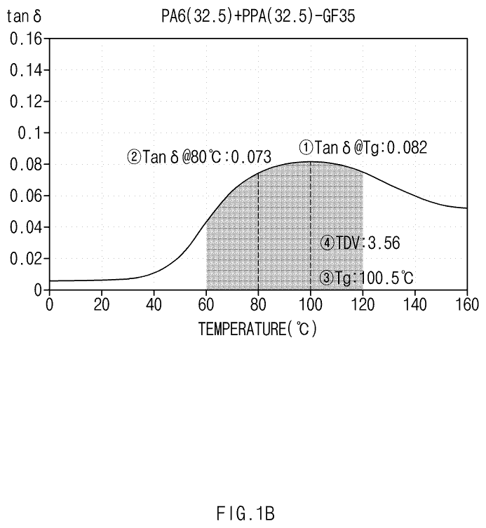

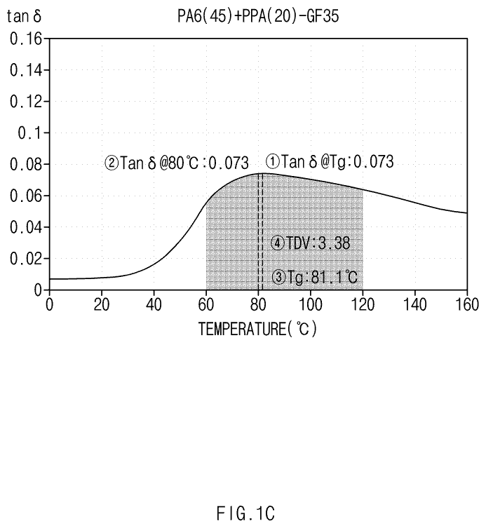

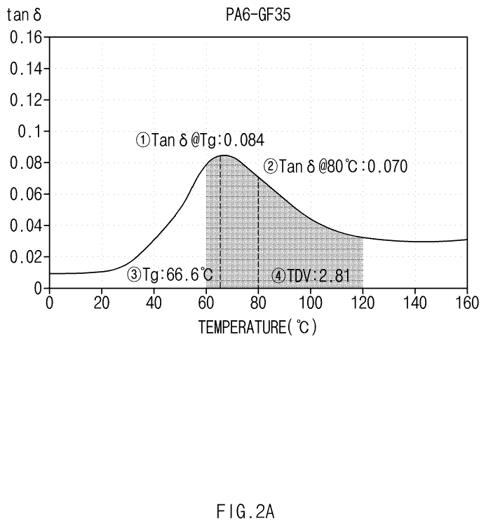

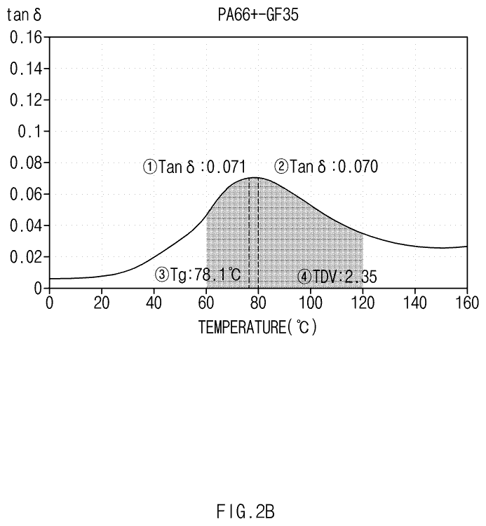

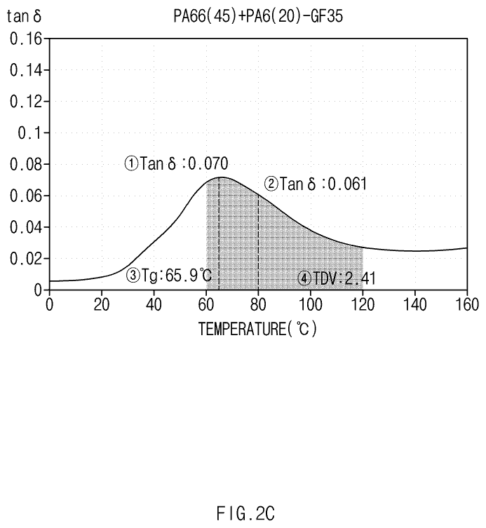

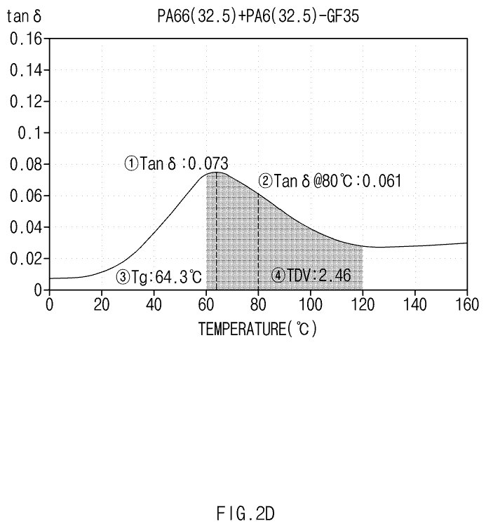

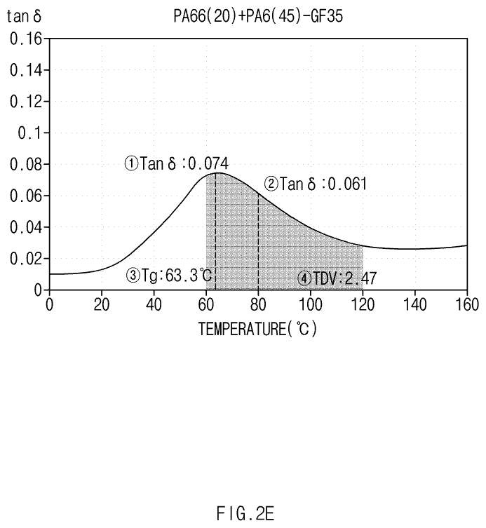

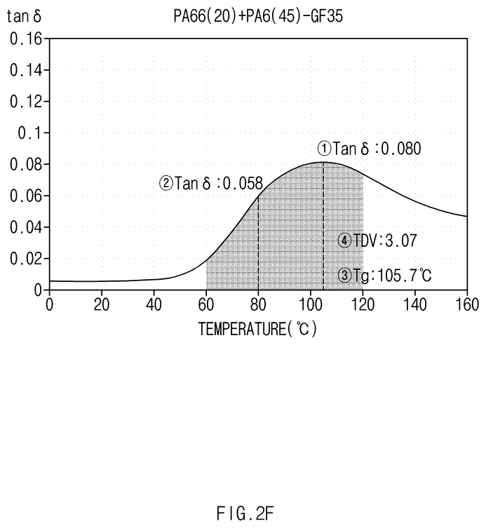

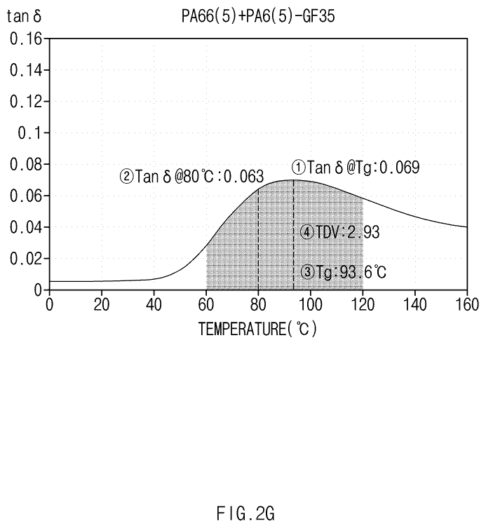

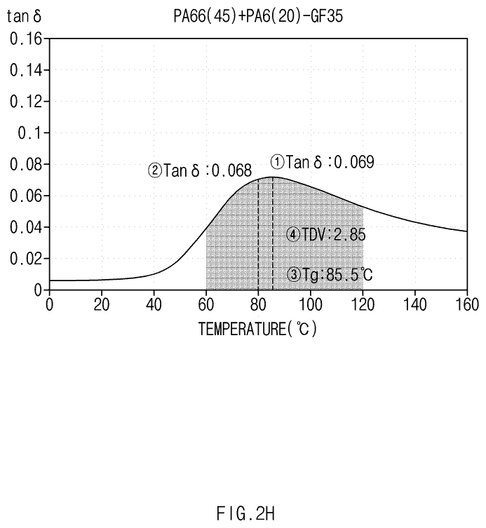

In this regard, in the above graph, the loss tangent (tan δ@80° C.) at 80° C. and the integral value (α) of the loss tangent in the temperature range between 60° C. and 120° C. are shown in Table 2 below. The temperature-dependent graphs of the loss tangent (tan δ) obtained by measuring the dynamic viscoelasticity of the specimens of Present Examples 1 to 3 are respectively shown in FIGS. 1A to 1C. The temperature-dependent graphs of the loss tangent (tan δ) obtained by measuring the dynamic viscoelasticity of the specimens of Comparative Examples 1 to 8 are respectively shown in FIGS. 2A to 2H.

TABLE 2

| | tanδ@80° C. | α |
|---|---|---|
| Present | 0.084 | 4.03 |
| Example 1 | | |
| Present | 0.073 | 3.56 |
| Example 2 | | |
| Present | 0.073 | 3.38 |
| Example 3 | | |
| Present | 0.074 | 3.44 |
| Example 4 | | |
| Present | 0.069 | 3.30 |
| Example 5 | | |
| Present | 0.064 | 3.19 |
| Example 6 | | |
| Present | 0.076 | 3.53 |
| Example 7 | | |
| Present | 0.072 | 3.36 |
| Example 8 | | |
| Present | 0.071 | 3.33 |
| Example 9 | | |
| Present | 0.075 | 3.44 |
| Example 10 | | |
| Present | 0.076 | 3.53 |
| Example 11 | | |
| Present | 0.069 | 3.28 |
| Example 12 | | |
| Comparative | 0.070 | 2.81 |
| Example 1 | | |
| Comparative | 0.070 | 2.75 |
| Example 2 | | |
| Comparative | 0.061 | 2.41 |
| Example 3 | | |
| Comparative | 0.061 | 2.46 |
| Example 4 | | |
| Comparative | 0.061 | 2.27 |
| Example 5 | | |
| Comparative | 0.058 | 3.07 |
| Example 6 | | |
| Comparative | 0.063 | 2.93 |
| Example 7 | | |
| Comparative | 0.068 | 2.85 |
| Example 8 | | |

Referring to Table 2 above, it may be noted that all of the loss tangents (tan δ) of the specimens in Present Examples 1 to 12 at 80° C. are within a numerical range of 0.068 to 0.090. Moreover, it may be noted that all of the integral values (α) of the loss tangent in the temperature range of 60° C. to 120° C. in Present Examples 1 to 12 are within the numerical range of 3.1 to 4.2.

Moreover, referring to Table 2 and FIGS. 1A to 1C, it may be noted that when the content of the aromatic polyamide-based resin is constant, the loss tangent (tan δ) at 80° C. and the integral value (α) of the loss tangent in the temperature range between 60° C. and 120° C. in Present Example 1 in which PA6T/6I is used as the aromatic polyamide-based resin are relatively larger than those in Present Example 4 employing PA6T/66 as the aromatic polyamide-based resin, Example 7 employing PA9T as the aromatic polyamide-based resin, and Present Example 10 employing PA10T as the aromatic polyamide-based resin. This fact may be noted through comparisons between Present Example 2 and Present Examples 5, 8, and 11; between Present Example 3 and present Examples 6, 9, and 12.

In contrast, referring to Table 2 and FIGS. 2A to 2E, it may be noted that in Comparative Examples 1 to 5 in which the aromatic polyamide-based resin is not included, all of the integral values (α) of the loss tangent in the temperature range of 60° C. to 120° C. are below the numerical range of 3.1 to 4.2. Moreover, it may be noted that in Comparative Examples 3 to 5, all of the loss tangents (tan δ) at 80° C. are below the numerical range of 0.068 to 0.090.

Moreover, referring to Table 2 and FIGS. 2F to 2H, it may be noted that in Comparative Example 6 to Comparative Example 8 in which PA66 is used as the aliphatic polyamide-based resin, all of the integral values (α) of the loss tangent in the temperature range of 60° C. to 120° C. are below the numerical range of 3.1 to 4.2. Moreover, it may be noted that in Comparative Examples 6 and 7, all of the loss tangents (tan δ) at 80° C. are below the numerical range of 0.068 to 0.090.

### Experimental Example 2: Comparison of Vibration Damping Performance Using a Complex Environmental Vibration Tester

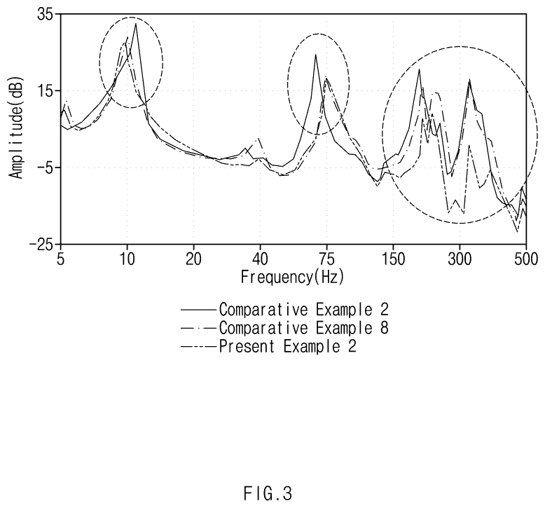

Vibration attenuation performance was measured on the specimens of Present Example 2, Comparative Example 2, and Comparative Example 8 using a complex environment vibration tester. The results are shown in FIG. 3, and the measurement condition thereof is as follows.

### Measurement Condition in Experimental Example 2

Vibration Excitation Mode: Sweep (1 to 1000 Hz)
Vibration Exciting force: 0.5 G
Evaluation environment: 80° C., RH90%

Referring to FIG. 3, it may be noted that an amplitude (Y-axis of the graph in FIG. 3) in the specimen of Present Example 2 in which the loss tangent (tan δ) at 80° C. is within the numerical range of 0.068 to 0.090, and moreover, the integral value (α) of the loss tangent in the temperature range of 60° C. to 120° C. is 3.1 to 4.2 is relatively smaller than that in each of the specimens of Comparative Examples 2 and 8 where the integral value (α) of the loss tangent in the temperature range of 60° C. to 120° C. falls below the numerical range of 3.1 to 4.2. Moreover, it may be noted that, especially as the frequency (X-axis of the graph in FIG. 3) increases, the amplitude in the specimen of Present Example 2 becomes smaller compared to the amplitude in each of the specimens in Comparative Examples 2 and 8. From this fact, it may be noted that the damping performance of the specimen of Present Example 2 against vibration that causes high-frequency noise is better than that of each of the specimens in Comparative Examples 2 and 8.

The molded article formed using the viscoelastic resin composition of the present disclosure may have excellent damping performance against vibrations that cause high-frequency noise.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A viscoelastic resin composition comprising:
an aliphatic polyamide-based resin; and
an aromatic polyamide-based resin,
wherein a weight ratio of the aliphatic polyamide-based resin and the aromatic polyamide-based resin is in a range of about 1:4 to about 1:0.25.

2. The viscoelastic resin composition of claim 1, wherein the aliphatic polyamide-based resin comprises a repeating unit represented by a following Chemical Formula 1: 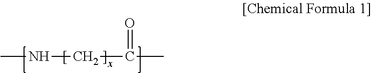
wherein the Chemical Formula 1, X is a natural number from 4 to 8.

3. The viscoelastic resin composition of claim 2, wherein the aliphatic polyamide-based resin is PA5 (nylon 5), PA6 (nylon 6), PA7 (nylon 7), a copolymer thereof, or a blend thereof.

4. The viscoelastic resin composition of claim 1, wherein the aromatic polyamide-based resin is a polyphthalamide resin, a copolymer thereof, or a blend thereof.

5. The viscoelastic resin composition of claim 4, wherein the polyphthalamide resin comprises at least one repeating unit selected from a group consisting of a repeating unit represented by a following Chemical Formula 2 and a repeating unit represented by a following Chemical Formula 3: 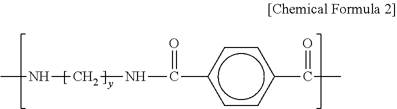
where in the Chemical Formula 2, Y is a natural number from 5 to 12, 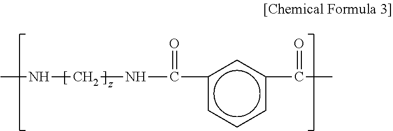
where in the Chemical Formula 3, Z is a natural number from 5 to 12.

6. The viscoelastic resin composition of claim 5, wherein the polyphthalamide resin is a copolymer comprising the repeating unit represented by the Chemical Formula 2 and the repeating unit represented by the Chemical Formula 3, and
wherein each of Y in the Chemical Formula 2 and Z in the Chemical Formula 3 is independently a natural number from 4 to 8.

7. The viscoelastic resin composition of claim 1, wherein a weight-average molecular weight of the aliphatic polyamide-based resin is in a range of about 1000 to about 80000 g/mol, and wherein a weight-average molecular weight of the aromatic polyamide-based resin is in a range of about 2000 to about 150000 g/mol.

8. The viscoelastic resin composition of claim 1, wherein the weight ratio of the aliphatic polyamide-based resin and the aromatic polyamide-based resin is in a range of about 1:4 to about 1:1.

9. The viscoelastic resin composition of claim 1, further comprising a filler.

10. The viscoelastic resin composition of claim 9, wherein the filler is a fibrous reinforcing material.

11. The viscoelastic resin composition of claim 10, wherein the fibrous reinforcing material comprises at least one selected from a group consisting of glass fiber, carbon fiber, graphite fiber, metal fiber, basalt fiber, cotton fiber, wool fiber, silk fiber, aramid fiber, polyacrylonitrile fiber, arylate fiber, polyether ketone fiber, nylon fiber, polyarylene terephthalate fiber, and a combination thereof.

12. The viscoelastic resin composition of claim 9, wherein when a total weight of the aliphatic polyamide-based resin, the aromatic polyamide-based resin, and the filler is 100 parts by weight, a content of the filler is in a range of about 30 to about 40 parts by weight.

13. The viscoelastic resin composition of claim 9, further comprising at least one selected from a group consisting of a heat resistant agent, a lubricant, and a combination thereof.

14. The viscoelastic resin composition of claim 13, wherein the heat resistant agent is at least one selected from a group consisting of a phenol-based compound; an amine-based compound; an oxide or hydroxide of Mg, Al, Sb, Zn or Mo; an iodinated inorganic compound, and a combination thereof.

15. The viscoelastic resin composition of claim 13, wherein the lubricant is at least one selected from a group consisting of a polyolefin-based compound, N,N′-bis(2,2,6,6-tetramethyl-4-piperidinyl), 1,3-benzenedicarboxamide, HALS, and a combination thereof.

16. A molded article of the viscoelastic resin composition of claim 1.

17. The molded article of claim 16, wherein a loss tangent (tan δ) of the molded article at 80° C. in a temperature-dependent graph of a loss tangent (tan δ) is in a range of 0.068 inclusive to 0.090 inclusive when obtained by measuring the molded article under a following measurement condition:
a dynamic viscoelastic behavior of a rectangular molded article having a length of 60 mm, a width of 13 mm, and a height of 3 mm manufactured using the viscoelastic resin composition is analyzed in a single cantilever bending mode (a measurement temperature range: 0 to 200° C., a temperature increase rate: 3° C./min, a measurement frequency: 3.2 Hz, a strain amplitude: 10 μm), and the temperature-dependent graph of the loss tangent (tan δ) is obtained based on the analyzed dynamic viscoelastic behavior.

18. The molded article of claim 17, wherein an integral value of the loss tangent (tan δ) in a temperature range of 60° C. to 120° C. in the temperature-dependent graph of the loss tangent (tan δ) is in a range of 3.1 inclusive to 4.2 inclusive.

19. The molded article of claim 18, wherein the temperature-dependent graph of the loss tangent (tan δ) has a maximum value in a temperature range from 60° C. to 120° C.

20. An electric mobility comprising the molded article of claim 16 used for an housing of an electric motor.
